(19) United States
(12) Patent Application Publication
(10) Pub. No.: US 2014/0025280 A1
(43) Pub. Date: Jan. 23, 2014

(54) SYSTEM AND METHOD TO DETERMINE RESTRICTION OF INDIVIDUAL EXHAUST GAS RECIRCULATION RUNNERS

(71) Applicants: JAMES P. WATERS, WATERFORD, MI (US); JAMES F. BURKHARD, CHURCHVILLE, NY (US)

(72) Inventors: JAMES P. WATERS, WATERFORD, MI (US); JAMES F. BURKHARD, CHURCHVILLE, NY (US)

(73) Assignee: DELPHI TECHNOLOGIES, INC., TROY, MI (US)

(21) Appl. No.: 13/551,761

(22) Filed: Jul. 18, 2012

(51) Int. Cl. F02B 47/08; F02D 41/26

(52) U.S. Cl. 701/108

(57) ABSTRACT

An engine control system and method for determining if an exhaust gas recirculation EGR runner between an EGR valve and a cylinder inlet is obstructed using a single exhaust gas sensor and individual cylinder fuel control (ICFC). A controller determines an off-state value based on an off-state air/fuel combustion ratio of a particular cylinder indicated by the single exhaust gas sensor while the EGR valve is operated to the off-state and while the engine is operating at a first speed-load condition, and determines an on-state value based on an on-state air/fuel combustion ratio of the particular cylinder indicated by the single exhaust gas sensor while the EGR valve is operated to the on-state and while the engine is operating at a second speed-load condition. The controller then determines if the EGR runner associated with the particular cylinder is obstructed based on the off-state value and the on-state value.

### TECHNICAL FIELD OF INVENTION

This disclosure generally relates to an individual cylinder fuel control system for an engine equipped with individual exhaust gas recirculation (EGR) runners, and more particularly relates to a way to determine if a specific individual EGR runner is blocked or obstructed.

### BACKGROUND OF INVENTION

Various techniques to mix exhaust gases into fresh air received by internal combustion engine cylinders are known. This practice is commonly known as exhaust gas recirculation (EGR) and is known to be useful to reduce engine emissions and improve fuel economy. A common way to introduce exhaust gas into the fresh air supply is to deliver the exhaust gas in a bulk-wise manner to a single port located just downstream of a throttle plate used to regulate a fresh air flow rate into the engine. However is has been discovered that when the EGR port is close to the throttle plate, there is a risk of the throttle plate accumulating tough-to-remove carbon deposits commonly known as coking and/or accumulating ice, either of which may degrade the ability of the throttle plate to regulate fresh air flow, particularly when the engine is idling. It has been suggested to route exhaust gases from a common EGR valve via individual EGR runners from the common EGR valve to distinct EGR ports located relatively close to the intake valve(s) for each individual cylinder, for example to a port in an intake passage that fluidicly couples a relatively large volume intake plenum to the intake valve(s) for each individual cylinder. However, it has been discovered that the individual EGR runners, which are typically relatively small when compared to the passageways used for bulk delivery of exhaust gases, may be prone to accumulate contaminants and become blocked, restricted, or otherwise obstructed; and so may lead to undesirable maldistribution of exhaust gases to each individual cylinder. This is particularly problematic in view of a requirement by the California Air Resources Board (CARB) that systems with individual EGR runners must be able to detect significant obstruction or plugging of an individual EGR runner.

### SUMMARY OF THE INVENTION

In accordance with one embodiment, an engine control system for controlling a multiple cylinder engine using individual cylinder fuel control (ICFC) is provided. The system includes an exhaust gas recirculation (EGR) valve, a plurality of EGR runners, a single exhaust gas sensor, and a controller. The EGR valve is configured to regulate flow of exhaust gas through the EGR valve. The EGR valve is operable to an off-state where exhaust gas is prevented from flowing through the EGR valve, and an on-state where exhaust gas flows through the EGR valve. The plurality of EGR runners are configured to direct exhaust gas from the EGR valve into each of a plurality of distinct intake passages for a plurality of cylinders of the engine. The single exhaust gas sensor is installed on the engine at a location effective to distinguish exhaust gas constituents arising from distinct combustion events in the plurality of cylinders. The controller is configured to determine an off-state value based on an off-state air/fuel combustion ratio of a particular cylinder indicated by the single exhaust gas sensor while the EGR valve is operated to the off-state and while the engine is operating at a first speed-load condition. the controller is also configured to determine an on-state value based on an on-state air/fuel combustion ratio of the particular cylinder indicated by the single exhaust gas sensor while the EGR valve is operated to the on-state and while the engine is operating at a second speed-load condition. The controller is also configured to determine if the EGR runner associated with the particular cylinder is obstructed based on the off-state value and the on-state value.

In another embodiment, an engine control system for controlling a multiple cylinder engine using individual cylinder fuel control (ICFC) is provided. The system includes an exhaust gas recirculation (EGR) valve, a first EGR runner, a second EGR runner, a single exhaust gas sensor, and a controller. The EGR valve is configured to regulate flow of exhaust gas therethrough. The EGR valve is operable to an off-state where exhaust gas is prevented from flowing through the EGR valve, and an on-state where exhaust gas flows through the EGR valve. The first EGR runner is configured to direct exhaust gas from the EGR valve into a first intake passage for a first cylinder of the engine. The second EGR runner is distinct from the first EGR runner. The second EGR runner is configured to direct exhaust gas from the EGR valve into a second intake passage for a second cylinder of the engine. The second intake passage is distinct from the first intake passage. The single exhaust gas sensor is installed on the engine at a location effective to distinguish a first exhaust gas constituent arising from a first combustion event in the first cylinder from a second exhaust gas constituent arising from a second combustion event in the second cylinder. The controller is configured to determine a first off-state value based on a first off-state air/fuel combustion ratio of the first cylinder indicated by the single exhaust gas sensor while the EGR valve is operated to the off-state and while the engine is operating at a first speed-load condition. The controller is also configured to determine a first on-state value based on a first on-state air/fuel combustion ratio of the first cylinder indicated by the single exhaust gas sensor while the EGR valve is operated to the on-state and while the engine is operating at a second speed-load condition. The controller is also configured to determine if the first EGR runner is obstructed based on the first off-state value and the first on-state value.

In yet another embodiment, a method for determining if an exhaust valve recirculation (EGR) runner is restricted is provided. The EGR runner is part of an engine control system for controlling a multiple cylinder engine using individual cylinder fuel control (ICFC). The system includes an exhaust gas recirculation (EGR) valve configured to regulate flow of exhaust gas therethrough. The EGR valve operable to an off-state where exhaust gas is prevented from flowing through the EGR valve, and an on-state where exhaust gas flows through the EGR valve. The system also includes a first EGR runner configured to direct exhaust gas from the EGR valve into a first intake passage for a first cylinder of the engine. The system also includes a second EGR runner that is distinct from the first EGR runner. The second EGR runner is configured to direct exhaust gas from the EGR valve into a second intake passage for a second cylinder of the engine. The second intake passage is distinct from the first intake passage. The system also includes a single exhaust gas sensor installed on the engine at a location effective to distinguish a first exhaust gas constituent arising from a first combustion event in the first cylinder from a second exhaust gas constituent arising from a second combustion event in the second cylinder. The method includes the step of determining a first off-state value based on a first off-state air/fuel combustion ratio of the first cylinder while the EGR valve is operated to the off-state and while the engine is operating at a first speed-load condition. The method also includes the step of determining a first on-state value based on a first on-state air/fuel combustion ratio of the first cylinder while the EGR valve is operated to the on-state and while the engine is operating at a second speed-load condition. The method also includes the step of determining if the first EGR runner is obstructed based on the first off-state value and the first on-state value.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an engine control system in accordance with one embodiment; and

FIG. 2 is a flowchart of a method of operating the system of FIG. 1 in accordance with one embodiment.

### DETAILED DESCRIPTION

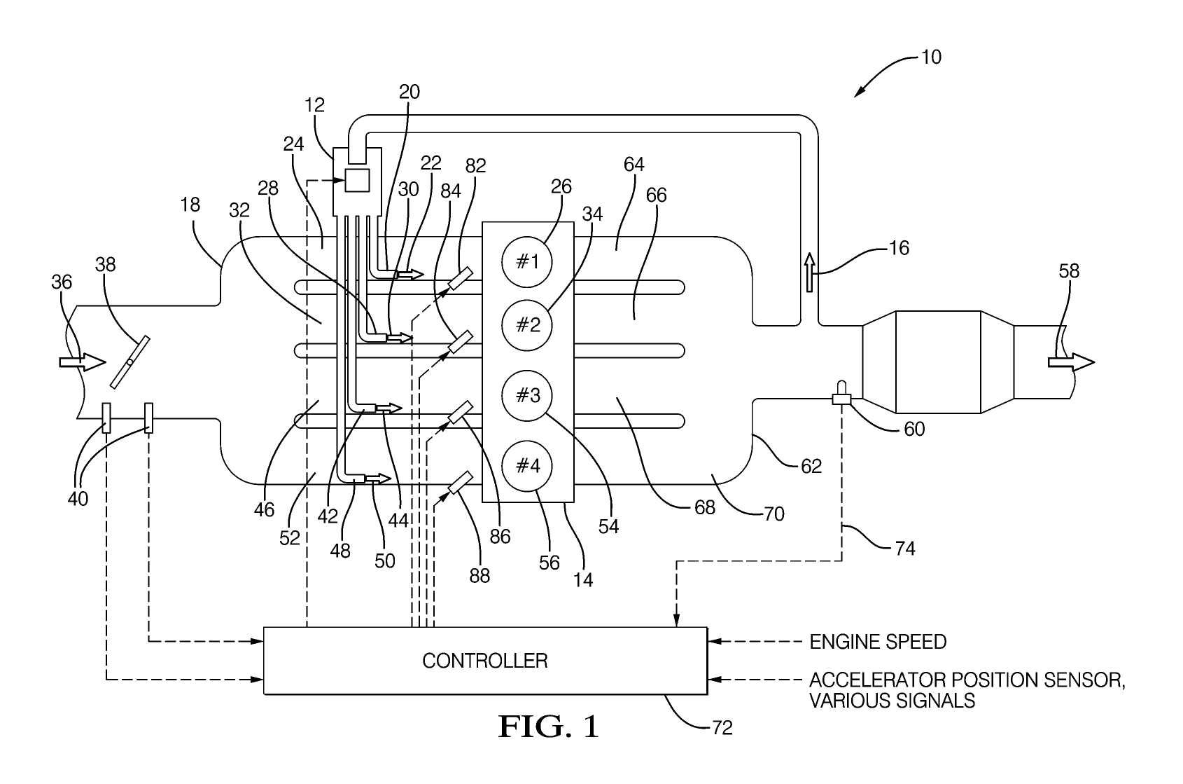

FIG. 1 illustrates a non-limiting example of an engine control system, hereafter system 10. In general, the system 10 is characterized as being able to control a multiple cylinder engine 14 using individual cylinder fuel control (ICFC). Such a system is available from Delphi Inc. of Troy, Mich., and is described in several technical papers such as Individual Cylinder Fuel Control with a Switching Oxygen Sensor by Jeff L. Kainz et al., Society of Automotive Engineering paper 1999-01-0546, published Mar. 1, 1999, and Individual Cylinder Fuel Control for Imbalance Diagnosis by James C. Smith et al., Society of Automotive Engineering paper 2010-01-0157, published Mar. 12, 2010 and U.S. Pat. No. 6,382, 198 to Smith et al., issued May 7, 2002. The entire contents of both papers and the patent are hereby incorporated herein by reference. The illustration in FIG. 1 suggests that the engine is an in-line four cylinder (I-4) type engine, but it will become apparent in the description that follows that the teachings set forth herein are applicable to engines configured with any number of cylinders, including V-6 and V-8 configured engines.

The system 10 may include an exhaust gas recirculation (EGR) valve, hereafter EGR valve 12. The EGR valve is generally configured to regulate flow of exhaust gas 16 expelled by the engine 14 into an intake manifold 18. In general, the EGR valve 12 is operable to an off-state where exhaust gas 16 is prevented from flowing through the EGR valve 12, and an on-state where exhaust gas flows through the EGR valve 12 and into the intake manifold 18. While this description may suggest that the EGR valve 12 is only either off or on, it is recognized that EGR valves are typically duty-cycled at some frequency, 128 Hertz (Hz) for example. Furthermore, it is contemplated that the teachings presented herein are also applicable to other types of variable flow EGR valves, sometimes referred to as linear EGR valves.

The system 10 may include a plurality of EGR runners for routing exhaust gas from the EGR valve 12 to a location proximate to a cylinder intake port. For example, the system 10 may include a first EGR runner 20 configured to direct exhaust gas 22 from the EGR valve 12 into a first intake passage 24 that directs intake air 36 to a first cylinder 26 (#1) of the engine 14; and a second EGR runner 28 that is a separate and distinct path for exhaust gas with respect to the first EGR runner 20. The second EGR runner 28 may direct exhaust gas 30 from the EGR valve 12 into a second intake passage 32 that directs intake air 36 to a second cylinder 34 (#2) of the engine 14. The EGR runners 20, 28 are typically formed of steel tubing and sized according to the flow requirements of the exhaust gas 22, 30 or can be incorporated into the design of intake manifold 18 as distinct runner passages. The second intake passage 32 defines a volume that characterized as separate and distinct from a volume defined by the first intake passage 24. Having separate and distinct volumes coupled to the intakes of distinct cylinders may be advantageous for tuning performance characteristics of the engine 14, as is well known in the art.

The system 10 may also include a throttle valve 38 configured to variably restrict the amount of intake air 36 flowing into the intake manifold 18. It will be recognized that when the throttle valve 38 restricts the intake air 36 while the engine 14 is operating, intake air pressure within the intake manifold may be reduced relative to ambient air pressure of air surrounding the engine 14. As such, the amount of exhaust gas 22, 30 flowing when the EGR valve 12 is in the on-state may be dependent on the difference between ambient air pressure and intake air pressure. The system may include one or more sensors 40, for example a manifold air pressure (MAP) sensor, an air temperature sensor (ATS), or a mass air flow (MAF) sensor that may be useful to estimate the amount of exhaust gas 22, 30 that is expected to be flowing from the first EGR runner 20 and the second EGR runner 28.

The engine 14 in this non-limiting example is a four cylinder engine, and so the system 10 may also include a third EGR runner 42 that is configured to direct exhaust gas 44 from the EGR valve 12 into a third intake passage 46 that directs intake air 36 to a third cylinder 54 (#3) of the engine 14; and a fourth EGR runner 48 that is configured to direct exhaust gas 50 from the EGR valve 12 into a fourth intake passage 52 that directs intake air 36 to a fourth cylinder 56 (#4) of the engine 14. Like the first intake passage 24 and the second intake passage 32, the third intake passage 46 and the fourth intake passage 52 define volumes distinct from other intake passages. In general, for any engine configuration, the system 10 includes a plurality of EGR runners (20, 28, 42, 48) configured to direct exhaust gas (22, 30, 44, 50) from the EGR valve 12 to each of a plurality of distinct intake passages (24,32,46,52) for a plurality of cylinders (26, 34, 54, 56) of the engine 14. It should be recognized that, for example, a six cylinder engine would have six distinct EGR runners with each EGR runner providing a distinct source of exhaust gas to six distinct intake passages.

It has been observed that having EGR valve controlled exhaust gas delivered to the engine 14 at a location proximate to the cylinder intake by EGR runners is preferable to delivering the EGR gas in bulk to a location proximate to the throttle valve 38 because it reduces instances of throttle icing and throttle coking, that is the accumulation of soot or other deposits on the throttle valve 38. However, because the individual EGR runners may be more prone to soot accumulation within the runners, it is desirable to determine if one or more of the EGR runners are obstructed, and so may be causing maldistribution of EGR gas to each cylinder. It will be recognized that maldistribution of EGR gas may cause the air/fuel mixture ratio delivered to a particular cylinder to be other than a stoichiometric mixture, and so may lead to increased levels of undesirable constituents in vehicle emissions 58.

It has been suggested that an engine control system be equipped with a distinct exhaust gas sensor for each cylinder of an engine for the purpose of detecting if a particular EGR runner associated with a particular cylinder-exhaust gas sensor pairing is obstructed. However, such an arrangement is undesirable because of the added cost of a separate exhaust gas sensor for each cylinder, and the additional cost and complexity to an engine controller necessary to receive and process all the separate exhaust gas signals.

Advantageously, the system 10 described herein relies on a single exhaust gas sensor 60 for multiple cylinders instead of a separate exhaust sensor for each cylinder. The single exhaust gas sensor 60 is installed on the engine 14 at a location selected so the single exhaust gas sensor 60 is able to distinguish exhaust gas constituents arising from distinct combustion events occurring in each of the plurality of cylinders. In the non-limiting example illustrated in FIG. 1, the single exhaust gas sensor 60 is installed on an exhaust manifold 62 at a location on the exhaust manifold so that the single exhaust gas sensor 60 is able to distinguish a first exhaust gas constituent 64 arising from a first combustion event in the first cylinder 26 from a second exhaust gas constituent 66 arising from a second combustion event in the second cylinder 34.

An optimum location for the exhaust gas sensor 60 on a given engine 14 and exhaust manifold 62 may be determined by empirical testing and/or computer modeling. It is recognized that testing or modeling is desirable to determine system characteristics such as a propagation time for exhaust gas from each cylinder to the single exhaust gas sensor 60 for a variety of engine operating conditions, and/or any sensing delay characteristic of the single exhaust gas sensor 60 that would likely need to be considered in order to distinguish the first exhaust gas constituent 64 from the second exhaust gas constituent 66.

If the location of the single exhaust gas sensor 60 is too close to the engine 14, it may be that the exhaust from one cylinder has a greater effect on the single exhaust gas sensor 60 when compared to exhaust from another cylinder. Conversely, if the location is too far away from the engine 14, the exhaust gas from the plurality of cylinders may be mixed to a degree that the first exhaust gas constituent 64 and the second exhaust gas are not distinguishable by any sensing means.

It is recognized that for certain engine configurations, a V-6 or V8 configuration for example, it may not be possible to use one exhaust gas sensor to distinguish exhaust gases from all six or eight cylinders. Therefore, as used herein, the term single exhaust gas sensor means, but is not limited to, one exhaust gas sensor per bank of cylinders. In this instance, the engine (illustration of a V engine not shown) may include a left cylinder bank having a plurality of left cylinders, and a right cylinder bank having a plurality of right cylinders., wherein the single exhaust gas sensor includes a single left bank exhaust gas sensor and a single right bank exhaust gas sensor. This means that the system 10 for a V-6 or V-8 engine would have a single exhaust gas sensor for the left bank of three or four cylinders of the V-6 or V-8 engine respectively, and another single exhaust gas sensor for the right bank of three or four cylinders. As such, it should be understood that the system 10 uses the single exhaust gas sensor 60 for at least a bank of two cylinders. In the non-limiting example illustrated in FIG. 1, it is understood that the single exhaust gas sensor 60 is able to separately distinguish from each other the first exhaust gas constituent 64, the second exhaust gas constituent 66, and a third exhaust gas constituent 68, and a fourth exhaust gas constituent 70.

The system 10 may include a controller 72 configured to receive a signal 74 from the single exhaust gas sensor 60. The controller 72 may include a processor (not shown) such as a microprocessor or other control circuitry as should be evident to those in the art. The controller 72 may include memory, including non-volatile memory, such as electrically erasable programmable read-only memory (EEPROM) for storing one or more routines, thresholds and captured data. The one or more routines may be executed by the processor to perform steps for determining if signals received by the controller 72 indicate that an EGR runner associated with the particular cylinder is obstructed.

In one embodiment, the single exhaust gas sensor 60 may be an oxygen sensor configured to output an oxygen signal when oxygen is a constituent present in the exhaust gas. It follows then that the controller 72 may be coupled to the oxygen sensor and further configured to determine the first off-state value and the first on-state value based on the oxygen signal.

In general, the controller 72 may be configured to determine if an EGR runner is obstructed by determining an off-state value based on an off-state air/fuel combustion ratio of a particular cylinder indicated by the single exhaust gas sensor 60 when the EGR valve 12 is operated to the off-state while the engine is operating at a first speed-load condition. As used herein, a speed-load condition is a way to characterize a state of engine operation that considers the operating speed of the engine 14, typically measured in revolutions per minute (RPM), and, for example, if the engine 14 is accelerating (high load), or coasting (low load), or the vehicle is cruising at a steady speed (moderate load). The controller 72 may also be configured to determine an on-state value based on an on-state air/fuel combustion ratio of the particular cylinder indicated by the single exhaust gas sensor 60 when the EGR valve 12 is operated to the on-state while the engine is operating at a second speed-load condition.

By way of example and not limitation, if the signal 74 from the single exhaust gas sensor 60 indicates that the air/fuel combustion ratio of a particular cylinder was stoichiometric (e.g. about 14.7:1), meaning that all or most of the fuel and all or most of the oxygen were consumed by the combustion event, then the off-state value may be set to 1.0. However, if the signal 74 from the single exhaust gas sensor 60 indicates that the air/fuel combustion ratio of a particular cylinder deviated from stoichiometric by ten percent lean (e.g. about 16.2:1), meaning a level of oxygen is present in the exhaust gas, then the off-state value may be set to 1.1.

By determining an off-state value corresponding to the air/fuel combustion ratio when the EGR valve 12 is not passing exhaust gas, it can be surmised that, for example, fuel injectors 82, 84, 86, 88 are dispensing the expected amount of fuel. Then, when the EGR valve 12 is turned on, the amount of oxygen going into the cylinder is expected to be reduced or diluted by an expected amount of exhaust gas introduced via an EGR runner. Accordingly, the amount of fuel dispensed by the fuel injector is reduced with an expectation to maintain a stoichiometric air/fuel combustion ration. If the single exhaust gas sensor 60 does not indicate that the air/fuel combustion ratio was stoichiometric, for example that oxygen was detected (e.g. the on-state value is 1.1), then that may be an indication that the EGR runner associated with the particular cylinder is obstructed based on the off-state value and the on-state value.

For the system 10, the controller 72 may be configured to determine a first off-state value based on a first off-state air/fuel combustion ratio of the first cylinder 26 indicated by the single exhaust gas sensor 60 when the EGR valve 12 is operated to the off-state while the engine 14 is operating at a first speed-load condition. The controller may be further configured to determine a first on-state value based on a first on-state air/fuel combustion ratio of the first cylinder 26 indicated by the single exhaust gas sensor 60 when the EGR valve 12 is operated to the on-state while the engine 14 is operating at a second speed-load condition. As such, the controller 72 can determine if the first EGR runner 20 is obstructed based on the first off-state value and the first on-state value.

It follows that the controller 72 may be further configured to determine a second off-state value based on a second off-state air/fuel combustion ratio of the second cylinder 34 indicated by the single exhaust gas sensor 60 when the EGR valve 12 is operated to the off-state while the engine 14 is operating at the first speed-load condition. The controller 72 may also be configured to determine a second on-state value based on a second on-state air/fuel combustion ratio of the second cylinder 34 indicated by the single exhaust gas sensor 60 when the EGR valve 12 is operated to the on-state while the engine 14 is operating at the second speed-load condition. As such, the controller 72 can determine if the second EGR runner 28 is obstructed based on the second off-state value and the second on-state value.

It should be recognized that at some speed-load conditions it may be undesirable to either turn the EGR valve 12 on, or turn the EGR valve 12 off. For example, at a high-speed and high-load condition, it may be undesirable to dilute oxygen to the engine by turning the EGR valve on. As such, while it may be desirable to determine the off-state value and the on-state value at the same speed-load condition for reasons of test consistency, it may be necessary to determine if an EGR runner is obstructed using a first speed-load condition that is distinct from the second speed-load condition. However it is also recognized that some speed load conditions are suitable for operating with the EGR valve 12 in both the on-state and the off-state, and so the first speed-load condition may be the same as the second speed-load condition.

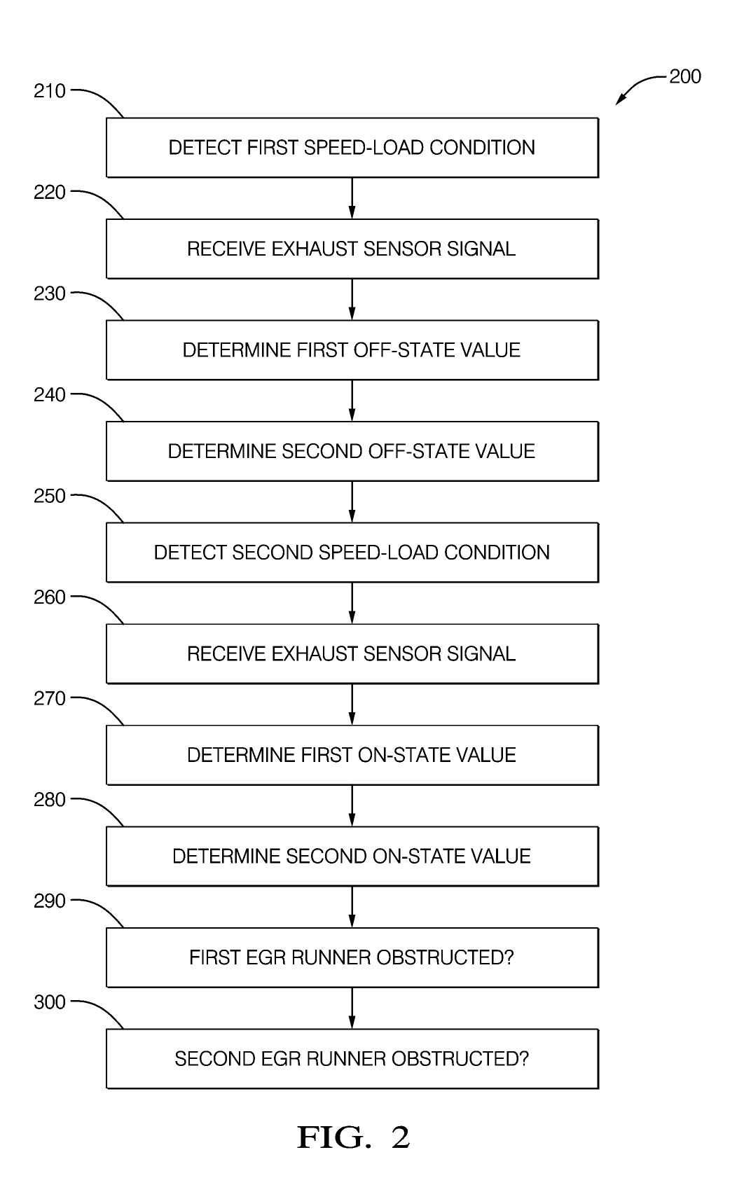

FIG. 2 illustrates a non-limiting example of a method 200 for determining if an exhaust valve recirculation (EGR) runner (20, 28, 42, 48) is restricted, blocked, or otherwise obstructed.

Step 210, DETECT FIRST SPEED-LOAD CONDITION, may include the controller 72 monitoring the engine 14 speed-load conditions until a speed-load condition favorable for operating the EGR valve 12 to an off-state to determine an off-state value arises.

Step 220, RECEIVE EXHAUST SENSOR SIGNAL, may include the controller 72 receiving, recording, and/or storing sampled values of the signal 74 from the single exhaust gas sensor 60, for example into memory within the controller 72.

Step 230, DETERMINE FIRST OFF-STATE VALUE, may include the controller 72 determining a first off-state value based on a first off-state air/fuel combustion ratio of the first cylinder 26 when or while the EGR valve 12 is operated to the off-state and while the engine 14 is operating at a first speed-load condition.

Step 240, DETERMINE SECOND OFF-STATE VALUE, may include the controller 72 determining a second off-state value based on a second off-state air/fuel combustion ratio of the second cylinder 34 indicated by the single exhaust gas sensor 60 when or while the EGR valve 12 is operated to the off-state and while the engine 14 is operating at the first speed-load condition.

Step 250, DETECT SECOND SPEED-LOAD CONDITION, may include the controller 72 monitoring the engine 14 speed-load conditions until a speed-load condition favorable for determining an on-state value arises. The second speed-load condition may be the same as, or different from, the first speed-load condition.

Step 260, RECEIVE EXHAUST SENSOR SIGNAL, may include the controller 72 recording or storing in memory sampled values of the signal 74 from the single exhaust gas sensor 60.

Step 270, DETERMINE FIRST ON-STATE VALUE, may include the controller 72 determining a first on-state value based on a first on-state air/fuel combustion ratio of the first cylinder 26 when the EGR valve 12 is operated to the on-state while the engine 14 is operating at a second speed-load condition; and

Step 280, DETERMINE SECOND ON-STATE VALUE, may include the controller 72 determining a second on-state value based on a second on-state air/fuel combustion ratio of the second cylinder indicated by the single exhaust gas sensor when the EGR valve is operated to the on-state while the engine is operating at the second speed-load condition, and determine if the second EGR runner is obstructed based on the second off-state value and the second on-state value.

Step 290, FIRST EGR RUNNER OBSTRUCTED?, may include the controller 72 comparing the first off-state value and the first on-state value to a threshold to determine if the air/fuel combustion ratio in the first cylinder 26 is substantially different from stoichiometry, for example more differs by more than 3% from stoichiometry. For the non-limiting example given above where an off-state value of 1.0 indicates stoichiometric combustion, an on-state value greater than 1.03 may indicate that the first EGR runner 20 is obstructed based on the first off-state value and the first on-state value.

Step 300, SECOND EGR RUNNER OBSTRUCTED?, may include the controller 72 comparing the second off-state value and the second on-state value to a threshold in a manner similar to that described for step 290.

Accordingly, a system 10, a controller 72, and a method 200 of determining if a first EGR runner is obstructed based on a first off-state value and a first on-state value, and if a second EGR runner is obstructed based on a second off-state value and a second on-state value using a signal from a single exhaust gas sensor 60. The system 10 and method 200 are advantageous over the prior art in that the single exhaust gas sensor 60 can be used to determine which of a plurality of EGR runners is obstructed.

While this invention has been described in terms of the preferred embodiments thereof, it is not intended to be so limited, but rather only to the extent set forth in the claims that follow.

We claim:

1. An engine control system for controlling a multiple cylinder engine using individual cylinder fuel control (ICFC), said system comprising:
an exhaust gas recirculation (EGR) valve configured to regulate flow of exhaust gas therethrough, said EGR valve operable to an off-state where exhaust gas is prevented from flowing through the EGR valve, and an on-state where exhaust gas flows through the EGR valve;
a plurality of EGR runners configured to direct exhaust gas from the EGR valve into each of a plurality of distinct intake passages for a plurality of cylinders of the engine;
a single exhaust gas sensor installed on the engine at a location effective to distinguish exhaust gas constituents arising from distinct combustion events in the plurality of cylinders; and
a controller configured to determine an off-state value based on an off-state air/fuel combustion ratio of a particular cylinder indicated by the single exhaust gas sensor while the EGR valve is operated to the off-state and while the engine is operating at a first speed-load condition, determine an on-state value based on an on-state air/fuel combustion ratio of the particular cylinder indicated by the single exhaust gas sensor while the EGR valve is operated to the on-state and while the engine is operating at a second speed-load condition, and determine if the EGR runner associated with the particular cylinder is obstructed based on the off-state value and the on-state value.

2. An engine control system for controlling a multiple cylinder engine using individual cylinder fuel control (ICFC), said system comprising:
an exhaust gas recirculation (EGR) valve configured to regulate flow of exhaust gas therethrough, said EGR valve operable to an off-state where exhaust gas is prevented from flowing through the EGR valve, and an on-state where exhaust gas flows through the EGR valve;
a first EGR runner configured to direct exhaust gas from the EGR valve into a first intake passage for a first cylinder of the engine;
a second EGR runner distinct from the first EGR runner, said second EGR runner configured to direct exhaust gas from the EGR valve into a second intake passage for a second cylinder of the engine, wherein the second intake passage is distinct from the first intake passage;
a single exhaust gas sensor installed on the engine at a location effective to distinguish a first exhaust gas constituent arising from a first combustion event in the first cylinder from a second exhaust gas constituent arising from a second combustion event in the second cylinder; and
a controller configured to determine a first off-state value based on a first off-state air/fuel combustion ratio of the first cylinder indicated by the single exhaust gas sensor while the EGR valve is operated to the off-state and while the engine is operating at a first speed-load condition, determine a first on-state value based on a first on-state air/fuel combustion ratio of the first cylinder indicated by the single exhaust gas sensor while the EGR valve is operated to the on-state and while the engine is operating at a second speed-load condition, and determine if the first EGR runner is obstructed based on the first off-state value and the first on-state value.

3. The system in accordance with claim 2, wherein the controller is further configured to determine a second off-state value based on a second off-state air/fuel combustion ratio of the second cylinder indicated by the single exhaust gas sensor while the EGR valve is operated to the off-state and while the engine is operating at the first speed-load condition, determine a second on-state value based on a second on-state air/fuel combustion ratio of the second cylinder indicated by the single exhaust gas sensor while the EGR valve is operated to the on-state and while the engine is operating at the second speed-load condition, and determine if the second EGR runner is obstructed based on the second off-state value and the second on-state value.

4. The system in accordance with claim 2, wherein the first speed-load condition is distinct from the second speed-load condition.

5. The system in accordance with claim 2, wherein the first speed-load condition is the same as the second speed-load condition.

6. The system in accordance with claim 2, wherein the single exhaust gas sensor is an oxygen sensor configured to output an oxygen signal when oxygen is a constituent present in the exhaust gas, wherein the controller is coupled to the oxygen sensor and further configured to determine the first off-state value and the first on-state value based on the oxygen signal.

7. The system in accordance with claim 2, wherein the engine is characterized as having a ‘V’ configuration defining a left cylinder bank having a plurality of left cylinders and a right cylinder bank having a plurality of right cylinders, wherein the single exhaust gas sensor includes a single left bank exhaust gas sensor and a single right bank exhaust gas sensor.

8. A method for determining if an exhaust valve recirculation (EGR) runner is restricted, wherein the EGR runner is part of an engine control system for controlling a multiple cylinder engine using individual cylinder fuel control (ICFC), said system comprising an exhaust gas recirculation (EGR) valve configured to regulate flow of exhaust gas therethrough, said EGR valve operable to an off-state where exhaust gas is prevented from flowing through the EGR valve, and an on-state where exhaust gas flows through the EGR valve, a first EGR runner configured to direct exhaust gas from the EGR valve into a first intake passage for a first cylinder of the engine, a second EGR runner distinct from the first EGR runner, said second EGR runner configured to direct exhaust gas from the EGR valve into a second intake passage for a second cylinder of the engine, wherein the second intake passage is distinct from the first intake passage, and a single exhaust gas sensor installed on the engine at a location effective to distinguish a first exhaust gas constituent arising from a first combustion event in the first cylinder from a second exhaust gas constituent arising from a second combustion event in the second cylinder, said method comprising the steps of:
determining a first off-state value based on a first off-state air/fuel combustion ratio of the first cylinder while the EGR valve is operated to the off-state and while the engine is operating at a first speed-load condition;
determining a first on-state value based on a first on-state air/fuel combustion ratio of the first cylinder while the EGR valve is operated to the on-state and while the engine is operating at a second speed-load condition; and
determining if the first EGR runner is obstructed based on the first off-state value and the first on-state value.

9. The method in accordance with claim 8, wherein method further comprises
determining a second off-state value based on a second off-state air/fuel combustion ratio of the second cylinder indicated by the single exhaust gas sensor while the EGR valve is operated to the off-state and while the engine is operating at the first speed-load condition; and
determining a second on-state value based on a second on-state air/fuel combustion ratio of the second cylinder indicated by the single exhaust gas sensor while the EGR valve is operated to the on-state and while the engine is operating at the second speed-load condition, and determine if the second EGR runner is obstructed based on the second off-state value and the second on-state value.
